(19) United States
(12) Patent Application Publication
(10) Pub. No.: US 2007/0208782 A1
(43) Pub. Date: Sep. 6, 2007

(54) Updating of Data Processing and Communication Devices

(75) Inventors: Marc Stanley Carter, London (GB); Lucas William Partridge, Southampton (GB); Bharat Veer Bedl, Southsea (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 11/621,697

(22) Filed: Jan. 10, 2007

(30) Foreign Application Priority Data
Jan. 10, 2006 (GB) GB0600348.7

(51) Int. Cl. G06F 17/30

(52) U.S. Cl. 707/201

(57) ABSTRACT

Provided are methods, computer programs and apparatus supporting cooperative updating of software, firmware and other data. A first device is able to obtain program and data updates that are required by other devices, and to do this altruistically even if the updates are not required by the first device. The updates obtained by the first device are saved in cache storage until they can be transferred to the other devices that require update support. A set of devices form a Data Sharing Group and hold information representing update requirements of the other group members. Altruistic obtaining and caching of updates can be especially beneficial for devices that have very limited network access—for example devices that have only intermittent network connectivity, or have low bandwidth or low security network connections. Some end-user devices and embedded data processing components can rely entirely on altruistic updating by another device, whereas other solutions may combine this update mechanism with conventional update mechanisms.

### FIELD OF INVENTION

The present invention provides methods, apparatus and computer programs for updating software, firmware and other data at data processing and communication devices.

### BACKGROUND

Data processing and communications devices need updating over time, for reasons such as maintaining security against the latest known security threats, correcting errors in software and enhancing the device functions. For many years, it has been necessary to install operating system security patches as and when they become available, and computer program vendors periodically provide enhanced versions of their programs. Additionally, many providers of software and firmware release products that are not fully tested or have limited functionality, relying on the ability to subsequently release error corrections and other updates.

A number of different mechanisms are known for updating software, firmware and other data, but each of the known mechanisms has associated problems or limitations.

In many cases, each device is required to update itself via network connections to a host computer that holds the latest versions and patches for a set of application programs and/or data files. This requires each device that requires updating to have an available network connection to the host. For downloading of large program files, there is a need for a relatively high-bandwidth, reliable connection. In other cases, updates only occur if and when initiated manually by a device user, but many device users do not wish to have such a personal intervention responsibility. Another update mechanism involves broadcasting from a central server to each device in a specific network, but this mechanism is typically limited to a particular class of devices registered with the central server and the broadcast will be missed by any devices that are offline at the time of the broadcast.

With each of the example update mechanisms described above, there remains a problem of how to ensure that all devices that require an update actually receive and install the update. This is especially problematic because of the increasingly pervasive nature of data processing and communication devices—since a device that is frequently switched off or only has low-bandwidth, unreliable and insecure wireless connectivity to a network cannot be relied on to obtain software updates as soon as they become available.

U.S. Pat. No. 5,019,963, assigned to International Business Machines Corporation, describes a solution for updating programs and other data files in a data processing network in which a number of workstations such as personal computers connect to a host computer. The workstations send a signal to the host indicating which files they have and at what level. The host determines if the workstation has the latest level program or other data file and, if it does not, sends a copy of the latest-level file to the workstation to replace the down-level file. Because the host's update action is in response to a signal from each workstation, the host is not required to maintain a record of the level of all files held at each workstation.

U.S. Pat. No. 6,904,457, also assigned to International Business Machines Corporation, describes a method, system and program for updating firmware within a set of nodes of a nodal system architecture. A querying node transmits a request to another node (‘queried node’) to determine the level of program code at the queried node. A response from the queried node is used to determine whether the queried node has a higher code level that can be used to update the querying node. Automating updates as described in U.S. Pat. No. 6,904,457 avoids the need for a technician to initiate each node's update.

US Patent Application Publication No. 2002/0194582 describes a system and method for providing automatic firmware updates and diagnostics for network-attached storage devices. A device initiating the updates may determine that it possesses the latest firmware revision, prompting updating of other network-attached storage devices; or the initiating device may discover that its firmware is older than the latest revision, prompting the initiating device to retrieve the latest firmware from another attached device.

### SUMMARY

A first aspect of the present invention provides a method for obtaining and storing updates to computer programs and/or other data on behalf of a data processing or communications device. The invention enables selective caching, at a first device, of updates identified by the first device as relevant to at least one other device.

The method can be implemented for ‘altruistic’ caching of selected updates at a first device—i.e. caching program or data updates that are required by a set of one or more known communication-partner devices, even if the first device does not need to cache the updates for its own use. The first device preferably holds a list of communication-partner devices and information for determining their update requirements. This list may be user-defined or based on usage records (e.g. the set of devices with which a first device communicates most frequently). Alternatively, a device may be selected according to the reliability and security of available connections.

For example, if a first end-user device has installed a software patch, it is conventional to subsequently retain only the ‘patched’ program at the end-user device—i.e. not to also retain a separate copy of the patch or a pointer to the patch in cache memory for the purpose of updating other devices. The present invention determines when it is desirable to save a copy of the patch (or a pointer) in cache memory to enable the patch to be communicated to one or more other devices.

In a second example, the first device may not require a software patch at all but may altruistically cache an update on behalf of another device. For example, the two devices may be running different operating system versions and a security patch saved in cache storage at the first device may relate to the operating system version running on the other device. Such altruistic obtaining and saving of updates by end-user devices on behalf of other devices is a departure from known solutions.

Although the updates that are cached on behalf of another device may be software patches or new firmware versions, they may also be virus definitions for use by antivirus software or any other data items such as news reports or stock prices.

The first device may obtain updates on behalf of other devices when obtaining updates that the first device itself requires, or at any other convenient time. The subsequent step of updating one of the first-device's set of communication-partner devices may also be performed at any convenient time, such as when the first device is next connected to the communication partner, or when a user or timer expiry initiates sharing of updates.

The first device may be, for example, a mobile telephone, a personal digital assistant (PDA) or another end-user device. Updates may be required to deal with viruses or to update the device's firmware, for example. The devices for which updates are cached may be other end-user devices such as an MP3 player, PDA or mobile telephone, or may be embedded computing devices such as within a car or home appliance. The first device could also be a network-connected personal computer that altruistically obtains updates on behalf of a user's mobile telephone or a device within the user's home and then automatically updates the other devices when a suitable connection becomes available.

In general, the first device may be any data processing or communications device having adequate network connectivity and bandwidth for downloading updates. Using the present invention, such a device could act as a proxy for any other device that it knows about. However, the invention provides particular advantages when caching updates on behalf of devices that have limited access to the network (for example, devices that are currently disconnected or only have slow connectivity via a dial-up service). In one embodiment, the first device may choose to avoid acting as a proxy for devices that are capable of obtaining updates from elsewhere.

A further aspect of the invention uses adaptive weightings for determining which devices to altruistically obtain updates for, and for managing which updates are obtained and retained in cache storage, and which updates can be removed from the cache. For example, a cached update may be deleted when the update has been received by each device within a defined list of devices (or when a timeout occurs if that is earlier). A successful updating of devices, or a failure, may be used as a criterion for updating the weightings.

Another aspect of the present invention provides a method and apparatus for cooperative updating of devices that includes assessing constraints and costs associated with transmitting an item between two devices, to determine whether an update transmission should take place at a particular time. In one embodiment, the constraints and costs are balanced against perceived benefits of the transmission. Another embodiment only obtains updates for a predefined set of devices that have no ability to obtain updates via a different mechanism. Another embodiment only obtains updates for a device when that device is determined to be currently disconnected from the network such that the device would miss an available update without altruistic support from a partner device.

### BRIEF DESCRIPTION OF DRAWINGS

Embodiments of the invention are described below in more detail, by way of example, with reference to the accompanying drawings in which:

FIG. 1 is a schematic representation of items held in storage at a first device A, for an embodiment of the invention;

FIGS. 2A and 2B show a sequence of steps of a method according to an embodiment of the invention;

FIGS. 3A to 3E provide a schematic representation of how items held at each of a set of three devices may be updated over time, according to an embodiment of the invention; and

FIGS. 4A and 4B show updating of saved items as the initial steps of a synchronization according to an embodiment of the invention.

### DETAILED DESCRIPTION OF EMBODIMENTS

The present invention is not limited to a narrow category of network-connected devices, and can be applied to the updating of firmware, software and data items for any of a large number of different types of wireless or wired-connection communication and data processing devices or apparatus. By way of example, however, an embodiment of the invention is described below for a set of devices including a mobile telephone, a personal digital assistant (PDA) and an MP3 player. These are examples of devices that are not generally expected to always be connected to a data communications network via a high-bandwidth, reliable and secure connection. The present invention provides a solution for updating such devices. The invention may be employed for updating software, firmware and other files, documents and other data items. The embodiment described below uses the example of software updates.

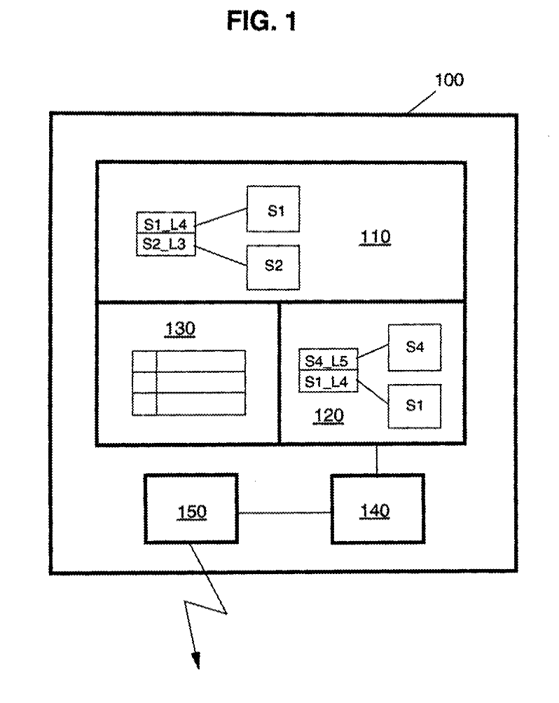

FIG. 1 is a schematic representation of a first device 100 in which the present invention is implemented. To aid understanding, the data storage of the first device 100 is represented as three separate storage areas 110, 120, 130. In some devices, the invention is implemented using a single database within a single data storage component, but for other devices there could be three separate storage components.

For implementations of the invention in which a first storage area is used to hold copies of programs required locally, and a separate storage area is used to hold programs required by other devices, the programs held on behalf of other devices may be held in a compressed format. A program reference held in one storage area may point to the storage location of a program in another storage area, to avoid storing duplicates. To optimize use of available storage, a device according to one embodiment of the invention caches a combination of (a) pointers to resources held at and required by the local device and (b) compressed copies of resources that are not required by the local device but are required elsewhere.

In FIG. 1, a first main storage area 110 within the device 100 holds a copy of a particular version of two application programs S1 and S2 together with identifiers of the programs and their code levels. An example format of an XML-based identification is represented herein as S1_L4 and S2_L3, where the respective code levels of the programs S1 and S2 are represented by the respective suffixes L4 and L3.

A second storage area, cache storage area 120, holds two application programs S4 and S1 that have been determined to be required by other devices, and XML-based identifiers S4_L5 and S1_L4. As noted above, the cache storage area 120 may hold the identifier S1_L4 and a pointer to the location of this program in the main storage area 110 instead of holding a duplicate copy of the program code. The program represented by S4_L5 may be held in a compressed format.

Thus, the cache storage area 120 of a first device 100 holds a copy of, or a pointer to, one of the files S1_L4 that was required by the local device, as well as a copy of a file S4_L5 that is not required by this local device. This caching of programs and data files on behalf of other devices is a first differentiation between the present invention and conventional end-user devices. A third data storage area 130 is used to maintain an inventory list of the application programs and their code levels held by other devices. As shown in FIG. 1, the inventory list is an empty data structure when the device 100 has not yet started cooperative update management with other devices.

The device 100 is equipped with a component 150 implementing a mechanism for the identification of communication-partner devices. This identification mechanism can be based on a known mechanism such as, for example, Bluetooth™, infrared or communications via an occasional LAN connection.

For the purposes of the present invention, it is sufficient to note that a number of known technologies enable data processing and communication devices to determine when communication is possible between them. According to the present invention, such a determination may be used as a trigger for synchronization between two devices. The identification of a partner device for cooperative data sharing is performed by the component 150 and a synchronization manager program 140 as described below.

In a first embodiment, the component 150 is a Bluetooth transmitter and receiver module. Bluetooth is a known wireless communication standard that is implemented by small, low-power radio-frequency communication modules within each Bluetooth-enabled device. When two Bluetooth-enabled devices come within range of one another, they each detect signals transmitted by the other device. The devices may connect to form a temporary personal area network and can start a conversation to determine whether they have data to share. Use of discovery, pairing and communication services within Bluetooth is described, for example, at Websites en.wikipedia.org (see en.wikipedia.org/wiki/Bluetooth) and www.bluetooth.com. In a first example implementation of the present invention, discovery and pairing of devices using Bluetooth is combined with establishment of ‘Data Sharing Groups’ and cooperation within groups, including altruistically obtaining data items such as code updates, and exchanging data items within the Data Sharing Group—as described below.

A ‘Data Sharing Group’ of data processing devices is, in the context of the present invention, a plurality of devices that cooperate by storing information regarding the data requirements of other devices within the group. The data processing devices could be laptop computers, PDAs, communication devices such as mobile telephones, embedded data processing components, or any other data processing devices. In a first embodiment, the members of a Data Sharing group hold inventories listing the data items such as versioned computer programs for which updates are required, but update requirements can be held in many different formats including topic names and other definitions of information of interest.

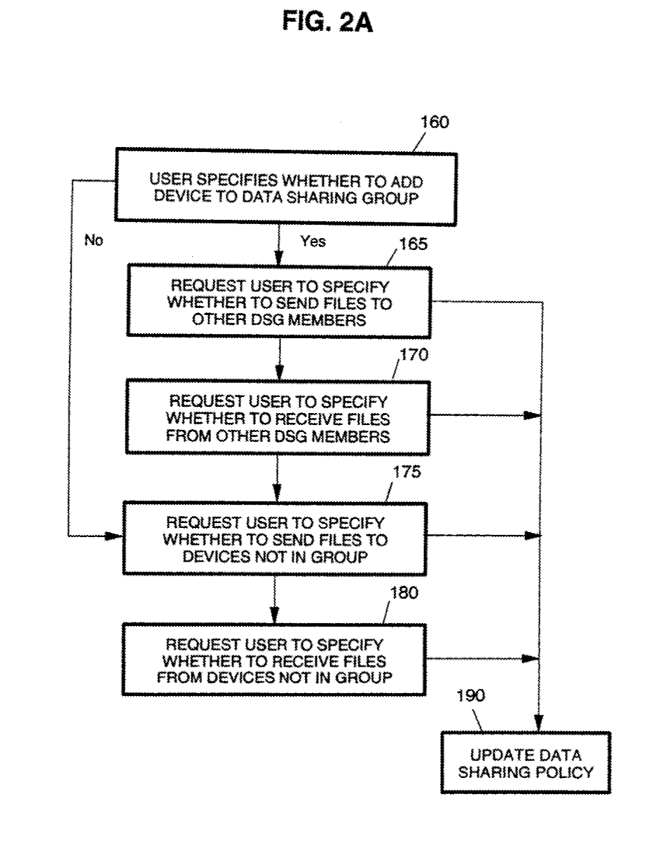

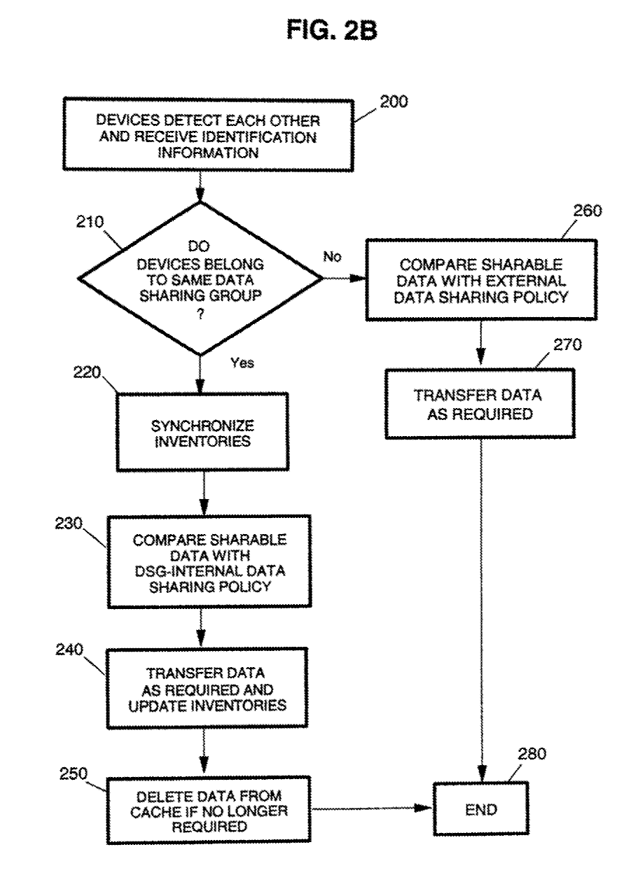

The steps performed by the synchronization manager 140 to implement a method according to the present invention are described in detail below with reference to FIGS. 2, 3 and 4. In a first example embodiment, a device user is responsible for defining a data sharing policy for each of his or her devices. References below to ‘he’ or ‘his’ are intended as shorthand for ‘he or she’ and ‘his or her’ respectively. The synchronization manager 140 includes a user interface for defining this policy. The user is able to specify 160 via this user interface whether he wishes the current device to be part of a Data Sharing Group. This could be part of an initial logon procedure when a user first interacts with a device, or may be a user-controlled device-setup step performed (and amended) at any convenient time.

In this first implementation, each device is limited to a maximum of one Data Sharing group at any one time, but a device may be moved to a different group and data sharing may be enabled with devices outside the Data Sharing Group. In other embodiments, overlapping of Data Sharing Groups is permitted.

Referring to FIG. 2A, if the user specifies 160 that the current device is to be part of a new Data Sharing Group, the user is prompted 165 by a message displayed via the user interface to specify whether the device will send data items to other Data Sharing Group members. The policy for the new Data Sharing Group is updated 190 to reflect the user's decision. The user is prompted 170 to specify whether the device will receive data items from other devices in the Data Sharing Group, and the policy is updated 190. The user is then prompted 175 to specify whether the device will send data items to devices not in the Data Sharing Group, and the policy is updated 190 accordingly. The user is then prompted 180 to specify whether the device will receive data items from devices not in the Data Sharing Group, and the policy is again updated 190.

The set of permitted values from which the user has selected can be represented as two independent tables, as shown below. Table 1 below represents the data sharing policy options within the Data Sharing Group (DSG), with ISR=1 (‘Internal_Send&Receive’) indicating that both sending and receiving are enabled, IS=1 (‘Internal_Send’) indicating that sending is enabled, IR=1 (‘Internal_Receive’) indicating that receiving is enabled, and IN (‘Internal_Null’; or ISR=(0,0)) indicating that neither sending nor receiving are permitted. A zero bit ‘0’ in the able below indicates that either sending or receiving is not permitted, whereas a positive bit ‘1’ indicates that sending or receiving is permitted.

TABLE 1
DSG Internal Policy

| Symbol | Send | Receive |
|---|---|---|
| ISR | 1 | 1 |
| IS | 1 | 0 |
| IR | 0 | 1 |
| IN | 0 | 0 |

Thus, the send and receive bits (SR) defining the data sharing policy for a device within its Data Sharing Group can take any one of the values (00), (01), (10) or (11). Steps 160 to 170 of FIG. 2A determines which of these values the device is initialised to.

Table 2 represents a policy for data sharing with devices outside the Data Sharing Group, with ESR representing ‘External_Send&Receive’, ES representing ‘External_Send’, ER representing ‘External_Receive’ and EN representing ‘External_Null’.

TABLE 2
DSG External Policy

| Symbol | Send | Receive |
|---|---|---|
| ESR | 1 | 1 |
| ES | 1 | 0 |
| ER | 0 | 1 |
| EN | 0 | 0 |

Similarly to the data sharing policy within the Data Sharing Group, one of the bit value pairs represented by a row in Table 2 will be selected as initial values for the external data sharing policy in response to steps 175 to 180 of FIG. 2A.

Having established the data sharing policy, the policy remains fixed for the device unless the device user initiates changes. However, a fixed policy may be accompanied by dynamic variations in whether data items are actually sent or received. This is because the synchronization manager has the capability to adapt data sharing behaviour according to network and device-specific conditions such as the device's battery power level, or connection bandwidth, quality or security. Variations can also be based on criteria that are specific to certain members of a data sharing group, such as a success rate for previous data transfers between two devices. This is described in more detail below.

Having established the data sharing policy for a device within a nominal Data Sharing Group, other devices can be added to the group and data sharing partnerships can be established. Each device can have a different selection of values from the two tables shown above.

For example, the set of possible data sharing relationships between two devices A and B can be represented as shown in Table 3 below. If both devices A and B belong to the same Data Sharing Group, their internal data sharing policies are used. If not in the same Data Sharing Group, their external data sharing policies are used.

TABLE 3

Device B

| | SR | 00 | 01 | 10 | 11 |
|---|---|---|---|---|---|
| Device A | 00 | X | X | X | X |
| | 01 | X | X | BA | BA |
| | 10 | X | AB | X | AB |
| | 11 | X | AB | BA | AB + BA |

In the above table, S and R represent the ‘Send’ and ‘Receive’ bits respectively. X indicates that no data transfer will take place, AB indicates transfer from A to B only, BA indicates transfer from B to A only, and AB+BA indicates that data transfer can take place in either direction between devices A and B. Which of these potential relationships exists between two devices is determined when they register with each other, and in some embodiments is updated when they synchronize with each other, as described below.

The relationship regarding whether devices will send to and receive from each other can, in combination with stored information regarding other device's update requirements, determine whether a device will cache software updates or other data items on behalf of other devices. For example, if a Data Sharing Group includes devices A and B, and device A is willing to send data items to device B, device A may also be willing to altruistically hold copies of data items in cache storage to facilitate retrieval by device B.

In other embodiments, a device may be configured to only download data items that are useful to that device, and not to download any data items that are not useful to that device. Such a device may still share downloaded data items with other devices. Sharing without altruistic downloading can be desirable for devices that are willing to cooperate with data transfers, but which have limited storage capacity, as such devices may be unable to justify caching data items unless they are required by the local device.

As shown in FIG. 2B, the registration and synchronization method starts with two devices each identifying 200 a new connection between them using the connection identification component 150. For example, the devices may be moved into close enough proximity for a Bluetooth connection, or the devices may identify each other's connection to a LAN when a second of the two devices is connected. The identification of a connection between devices and the exchange of device identification information and communication capability information is well known in the art.

If the devices were previously registered with each other as partner devices within a Data Sharing Group, the connection and device identification step 200 provides sufficient information for the synchronization manager 140 to recognize the respective devices as members of the same Data Sharing Group. The exchanged device identification information is compared 210 with a list of registered communication partners (members of the same Data Sharing Group) to determine whether the newly connected devices are registered communication partners. If a matching entry is found in the list of registered partners, the devices exchange 220 inventory information, updating their respective inventory lists of application programs and code levels for devices within the Data Sharing Group.

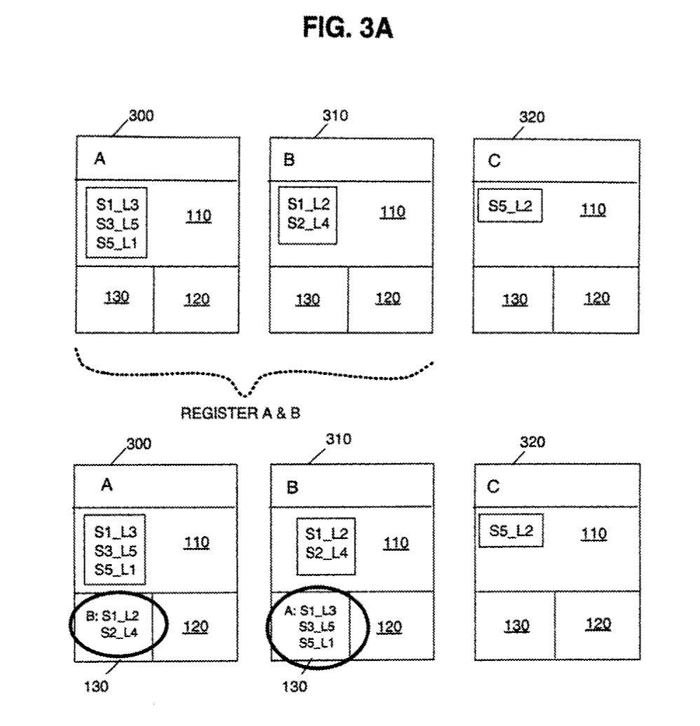

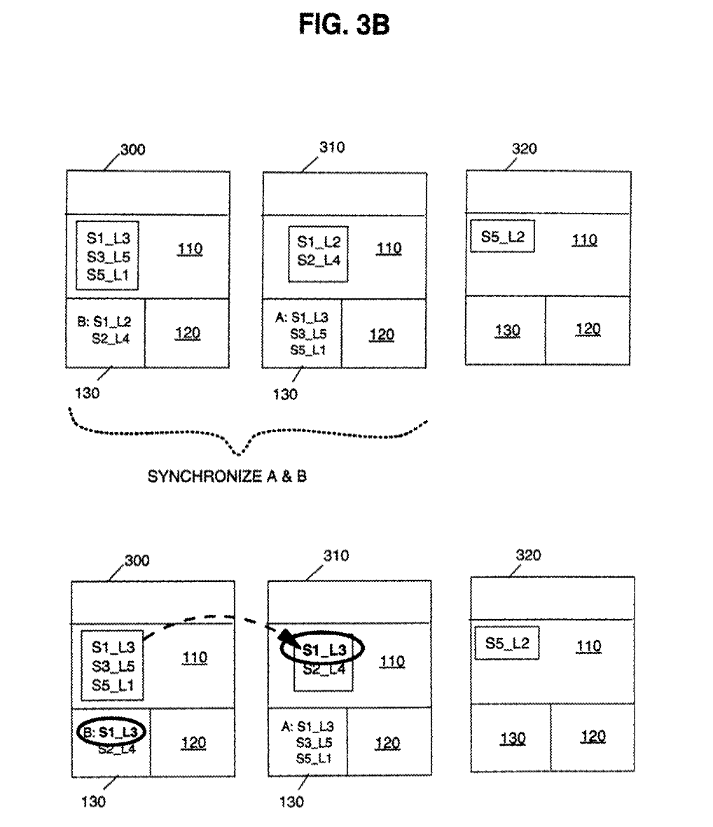

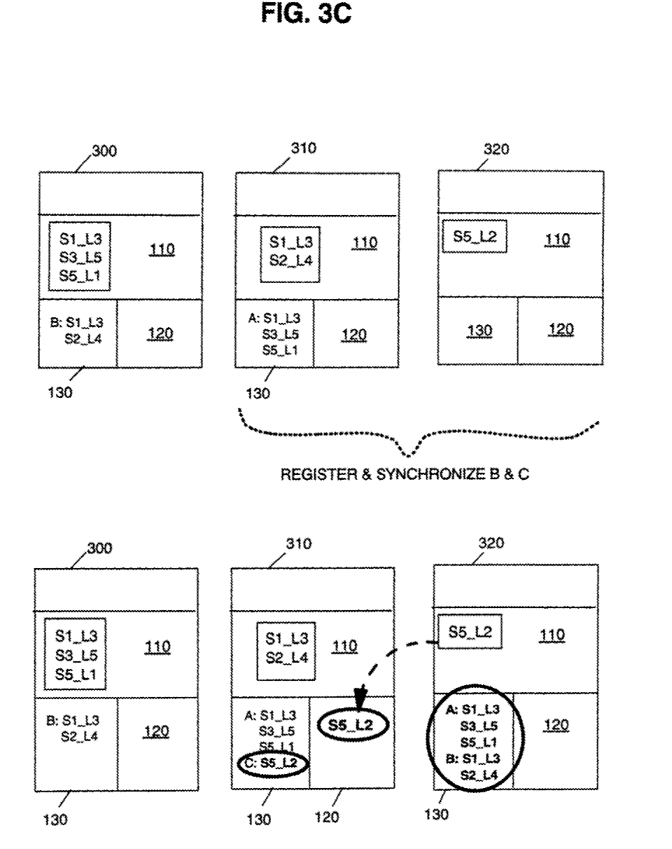

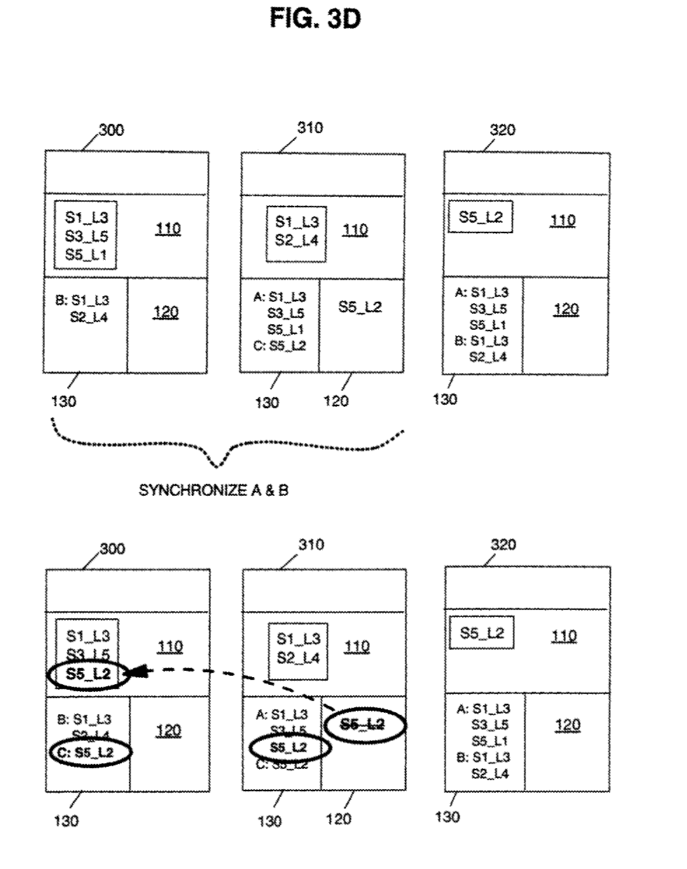

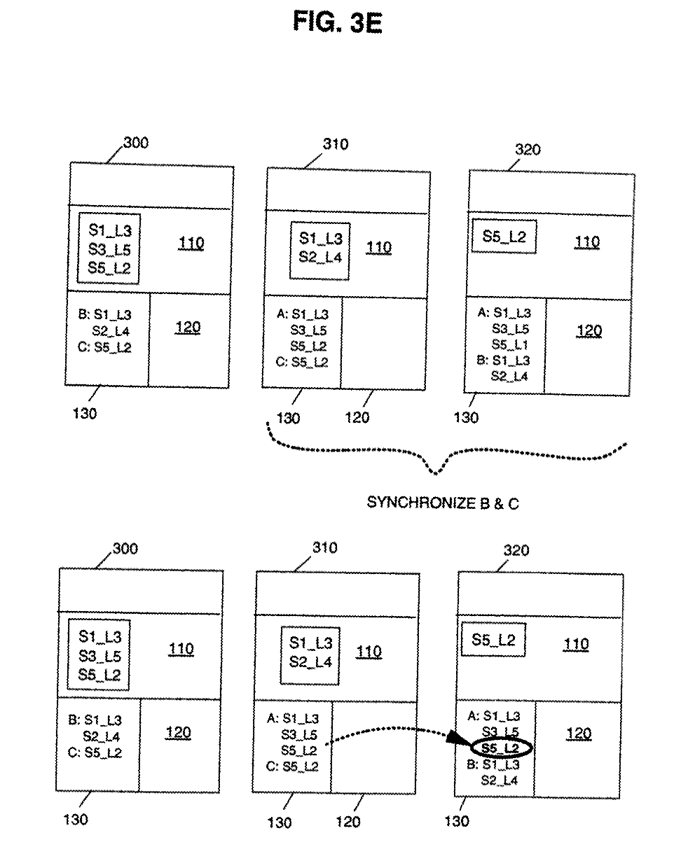

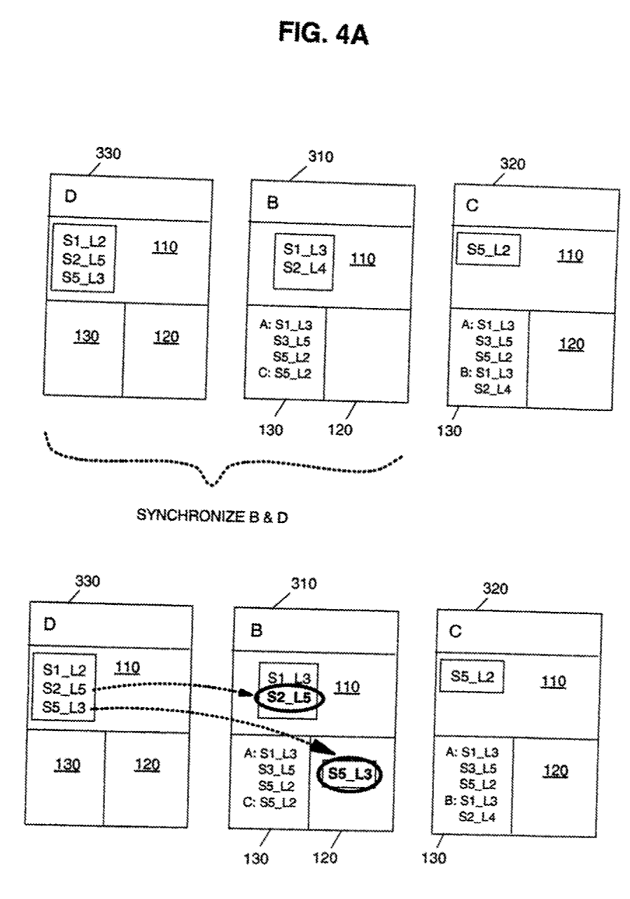

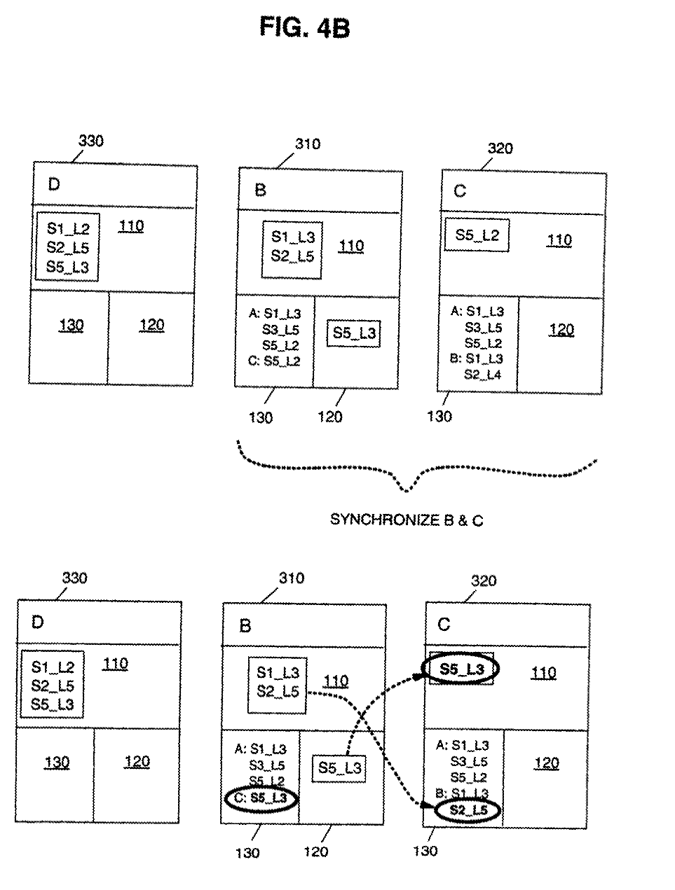

The data sharing relationship between devices in the Data Sharing Group results from their respective data sharing policies (see Table 3) and the policies are checked 230 to determine whether the devices are willing to provide update support for each other as a reciprocal relationship, or as a one-way relationship, or merely to exchange inventories. Synchronization of stored data items can then begin—with devices transferring 240 required data items to other devices according to their data sharing policies. The devices' respective inventories are also updated 240 to reflect which levels of application programs are held by each device following the transfers. A check is then performed of whether a data item that was altruistically cached at a device can now be deleted 250 from the cache, or whether the data item should remain in the cache for transfer to additional devices within the Data Sharing Group. Following deletion 250 from the cache of data items that are no longer required, the current execution of the synchronization process ends 280. The synchronization processing represented by steps 220-250 of FIG. 2B is described in more detail below with reference to FIGS. 3B-3E and 4B.

If the comparison 210 of an identified device with the list of devices in the Data Sharing Group does not identify a match, the data sharing policy for members of the Data Sharing Group is not applicable. Instead, available data items and data requirements of the communicating devices are compared 260 with reference to the external data sharing policies of the two devices. For devices that are willing to transfer data items to devices outside their data sharing group, and which are communicating with devices that require an available data item, the required data items are transferred 270. The transfer of data items completes the synchronization in such cases (without any updating of inventories and without deletion of data items from cache storage) and so the current execution of the synchronization process ends 280. An example of steps 260-270 is described below with reference to FIG. 4A.

Referring to FIG. 2B in more detail, the step 210 of determining whether two devices are within the same Data Sharing Group determines that the internal data sharing policy of the Data Sharing Group is to be used. The stored bit values representing whether the current device should send and receive data items (see Table 3) may be processed at this point by applying weightings representing conditions such as the available communication bandwidth and security, or conditions such as the battery power and storage space available to the device. Such conditions may be selected for their relevance to the likelihood of a successful data transfer. The use of weightings is described below in more detail in the context of an alternative embodiment of the invention, but a first embodiment described below relies on the established data sharing policies without such weightings.

For two devices A and B that have been identified as within the same Data Sharing Group, a check is performed 230 of whether data transfers from A to B are permitted. If so, a check is performed 230 of whether device A has any data items that are required by device B (either for itself or its other Data Sharing Group partners). This check may be limited to data items held in cache storage area 120 or it may include checking data items in the main storage area 110 and cache 120. If the policy check and requirement check both give positive results, relevant data items are transferred 240 from device A to the main storage area 110 or cache storage area 120 of device B. Device A's inventory list of data items held at device B is then updated 240. In the current embodiment, the inventory update is only performed if B obtained a data item for its own use (i.e. saved the data item to its main storage area 110) and data items saved altruistically to B's cache storage area 120 are not referred to in device A's inventory.

Subsequently, prior to, or in parallel with the check regarding transfers from A to B, a check is performed 230 of whether transfers are permitted from device B to device A. This is accompanied by a check 230 of whether device B has any data items required by device A. If the policy check and requirement check both give positive results, relevant data items are transferred 240 from device B to device A and device B's inventory list is updated 240 to reflect changes to the set of data items held in the main storage area 110 of device A.

In one embodiment, data items held in the cache 120 may be overwritten by later versions of the same data items that have been transferred from another device. This is appropriate when the data item in question is simply a later version of a software patch that does not require an earlier patch to be applied first. However, if the data item is a later piece of news, for example, and the user does not wish to lose an earlier piece of news on the same topic, the earlier data item should not be overwritten. When configuring a device for data sharing, the user can choose to be notified before a data item held in the cache 120 is overwritten by a later version of the same data item. The user can then choose whether to overwrite the earlier version, accept the later version alongside the earlier version, or even to abort the transfer of the later version altogether.

When all data items have been transferred 240, a check is performed 250 of whether any data items can be deleted from either device's cache storage area 120. In the present embodiment, any data items that are required by other members of the Data Sharing Group will be retained in cache storage of the respective provider device (subject to any timeout conditions or user-activated deletions). Any data items that appear (from the inventory of a current device) not to be required by other devices are deleted 250 from cache storage of the current device.

Steps 260-270 of FIG. 2B provide an overview of the steps performed when two communicating devices are determined not to be within the same Data Sharing Group. To describe this in more detail, the stored bit values representing the ‘external’ data sharing policies of the two devices are applicable in this situation instead of the policy for data sharing within the Data Sharing Group. Similar to the checks and data transfers described above, a policy check and requirement check are performed 260 for each transfer direction between the two devices. A corresponding transfer 270 of data items is performed when the checks yield positive results for a particular transfer direction.

As noted above and as represented in Table 3, data sharing policies may define one-way or reciprocal update partnerships. For example, a requesting device may wish to establish a dependent relationship on a communication-partner device without offering reciprocal update support. Since many devices cannot offer satisfactory network connectivity to provide update support for other devices, it is desirable to permit one-way update partnerships.

For example, one-way partnerships may be most suitable for asymmetric speed communications links such as an Asymmetric Digital Subscriber Line (ADSL). Another example is where a device is prepared to send updates to other devices but not to receive them (for example if the particular user is concerned about the security of either his device or the Data Sharing Group to which the device belongs). In another example, two users of mobile telephones may wish to establish a reciprocal relationship such that they can assist each other with software updates. It is desirable to enable the reciprocal option as well as one-way update partnerships, and to allow zero-way update partnerships in which only inventory information is held on behalf of another device.

For each of one-way and reciprocal update partnerships, a requesting device will notify the other device of its update requirements by providing a list of programs installed at the requesting device and their code levels. A determination 230,260 of whether to refuse or accept the request is based on stored bit values representing the data sharing policies. In some embodiments, the decision regarding whether to transfer data items (and even whether to accept or reject a device's request to form a Data Sharing Group) can be based on a set of criteria including, but not limited to, characteristics of the available network connections, battery power, the amount of memory space available at the respective devices, and/or a profile defined for each device's synchronization manager regarding which devices to accept requests from. This profile may be as simple as a user-defined list of devices, or could refer to classes of device, times of day, or the current level of activity of the request-receiving device. A user might also elect to be prompted for confirmation before a data item is transferred.

If a device receives a request to establish a reciprocal update partnership with another device, and a decision is made to accept the request, the synchronization manager of the device that receives the request can save an identification of software that was included in the request in its inventory list in storage area 130. The receiving device's synchronization manager then replies by sending to the requestor a list of its own installed programs and their code levels. This provides the original requestor with a representation of the update requirements of the device to which it sent the original request.

The exchange of lists of programs and data files (and the subsequent cooperative updating described in detail elsewhere in this specification) may be applied to only a limited subset of installed programs and data rather than all files. For example, a device user may specify which of his files or file types can be shared, or this may be specified by the device manufacturer within a device-specific profile. The synchronization manager is configured to constrain sharing to the limited subset, for example when application programs and the synchronization manager are installed on the device. Other programs and data that are not within the subset may be updated using any conventional mechanisms (such as requiring each device to contact a central server, or via a server-controlled distribution), and items within the subset can still be updated using conventional mechanisms when suitable network connections are available.

Thus, stored bit values representing data sharing policies determine which program and data files will be copied from one device to another. The information exchanged between devices and the data sharing policies managed by the synchronization managers generally set the boundaries for cooperative updating.

FIGS. 3A, 3B, 3C, 3D and 3E show how the exchanged information is used by some example communication partner devices within a Data Sharing Group, to achieve reciprocal updating of software. FIG. 3A includes a representation of items held in storage at three wireless devices 300, 310 and 320 before synchronization processing begins. Any files that would be disregarded by the synchronization managers are not shown in FIG. 3. By way of example, device A 300 is a mobile telephone, device B 310 is a PDA and device C 320 is an MP3 player. The invention is also applicable to wired-connection devices. One example solution employs a laptop to receive program code or other data updates via a wire connection, and then transfers the updates to a set of other devices wirelessly or otherwise.

Before synchronization, device A holds three program files S1_L3, S3_L5 and S5_L1. Device B holds two files S1_L2 and S2_L4. Device C holds a single program file S5_L2. In a first registration and inventory synchronization step 240, devices A and B register with each other to become update partners and exchange information regarding their installed program files. Device B saves a record in storage area 130 of the program files held at device A:

A: S1_L3, S3_L5, S5_L1

Device A saves a record in its respective storage area 130 of the program files held at device B:

B: S1_L2, S2_L4

Referring to FIG. 3B, the processing sequence continues with the synchronization manager at device B comparing 250 its record of program files on device A with the set of files held in the local main storage area 110. The synchronization manager on device B also checks its local cache storage area 120 but in this case finds no files held there. The synchronization manager on device B determines that a later release of program S1 is available on device A. The synchronization manager at device B requests a copy of the later version S1_L3 from device A. Assuming S1_L3 fits the profile of program files that can be shared between devices A and B, device A sends 260 a copy of S1_L3 to device B. The transmitted copy is then saved in the main storage area 110 of device B. Device A updates its inventory of files to reflect the update of device B's files. The result of this first synchronization step is shown in FIG. 3B.

As a next registration and synchronization, device B 310 and device C 320 register with each other and synchronize between their installed program files. The registration step 240 informs device B that device C holds a Level 2 version of program S5. Similarly, device C is informed that device B holds a Level 3 version of program S1 (represented by S1_L3) and a Level 4 version of program S2 (represented by S2_L4). Device C is also informed that device B is an update partner for device A, which holds files represented by:

A: S1_L3, S3_L5, S5_L1

Although S5 is not a program installed at device B, the update S5_L2 is required at device B to enable updating of device A that is a registered communication partner of device B. Having checked that there is no copy of the update represented by S5_L2 in cache storage area 120 of device B, the update S5_L2 is copied 260 from device C to device B and is saved in the cache storage area 120 of device B. FIG. 3C shows the updated set of program files and file references following this second synchronization.

The description above shows how a first device B can obtain updates on behalf of another connected device A, and save them to cache storage at device B to enable subsequent transfer to device A. This is referred to herein as ‘altruistic’ caching of updates. The update S5_L2 has yet to be passed to the device that requires it (device A), but the updated program S5_L2 has been transferred to device B and this facilitates access by device A.

A further synchronization between devices A and B produces a result as shown in FIG. 3D. The transfer of installed program information notifies the synchronization manager on device A that an updated program file S5_L2 is available on device B. Since this file is not yet available on device A (including in the cache storage area of device A), the file is copied to device A and saved to the main storage area 110. The inventory list held at device B is also updated. Now all devices A, B and C within the update group that hold a copy of program file S5 are holding a copy of the latest available release S5_L2.

Since no further updating is required, the copy of S5_L2 (or pointer to it) within the cache storage area 120 of device B can be deleted, as determined at step 270 of FIG. 2. The cached file is marked 280 as deleted. The only information which is now unsynchronized is the inventory list at device C, which incorrectly suggests that device A holds S5_L1. At the next synchronization between devices B and C, the inventory list on device C is updated to reflect the level of program S5 that is currently installed at system A—as shown in FIG. 3E.

In wireless communications, it is common for only a partial data transfer to take place. For example, two devices may be separated beyond their communication range, or a device may run out of battery power during a data transfer. In the method described above, inventories representing the data items such as program updates saved at other devices within a Data Sharing Group are transferred before the data items themselves are transferred. This avoids unnecessary data transfers but also ensures that devices can be made aware of the data items that are available at the other devices even if a full synchronization cannot be completed.

This propagation of inventories can be useful since it can be used to generate an alert on a device that desirable data items are available. For example, the device user can be alerted to the fact that a software patch is available or that the virus definitions being used on the device are not the latest that are available. Notifying a user of the desirability of updating may encourage the user to facilitate communications between his device and another device and so achieve earlier updating than would have occurred without the transfer of inventories.

The determination of which of two inconsistent inventory lists takes precedence may be based on an assumption that any reference to a later release of each program should take precedence over a conflicting reference to an earlier release. This assumption will be valid in most cases, because programs should not be replaced by an earlier version of the same program. Alternatively, the determination of precedence may be based on timestamps instead of highest version numbers.

The example shown in FIGS. 3A to 3E relates to a set of three devices that are each part of a reciprocal communication partnership or ‘Data Sharing Group’. As mentioned above, altruistic obtaining and caching of updates on behalf of members of a Data Sharing Group can be combined with transfers to devices that are not members of a Data Sharing Group. This is explained below by way of example, with reference to FIGS. 4A and 4B.

FIGS. 4A and 4B show the initial stages of a series of synchronizations between devices that include altruistic caching of updates at devices on behalf of other devices. FIG. 4A shows two devices B and D that may be synchronized. Device B is part of a Data Sharing Group including devices A and C, and holds two program files S1_L3 and S2_L5 in its main storage area 110 as well as holding in its inventory list a record of files held by devices A and C:

A: S1_L3, S3_L5, S5_L2

C: S5_L2

Device D is not a member of a Data Sharing Group (although it could be a member of a different Data Sharing Group from the other devices A, B and C). Device D holds three files in its main storage area 110, as represented by S1_L2, S2_L5 and S5_L3. The first thing to note here is that program file S2_L5 is an updated version of one of the program files held in the main storage area 110 of device B, whereas a second file S5_L3 is an update for one of the files held by devices A and C.

If device B synchronizes with device D without registering with each other as a new Data Sharing Group, files may be transferred (as described below) but the inventory lists of the two devices will not be compared or updated as part of that synchronization. This is because the synchronization managers of the two devices have not agreed to provide ongoing update support for each other.

When devices B and D synchronize with each other, device D's program file S2_L5 is used to update device B's file S2_L4 in device B's main storage area 110. Additionally, the synchronization manager running on device B identifies program files S5_L3 as an update to a program file held by devices A an C (communication-partner devices within B's Data Sharing Group). The synchronization manager at device B altruistically obtains a copy of file S5_L3 on behalf of its communication partners A and C, and saves the file to the cache storage area 120.

As shown in FIG. 4B, when device B next synchronizes with device C, the program file S5_L3 is copied from the cache storage area 120 of device B to the main storage area 110 of device C. The inventory lists of devices B and C are also updated as shown in FIG. 4B. The file S5_L3 is not yet deleted from the cache storage area of device B because the synchronization manager on device B determines that the file S5_L3 is also required by device A. A subsequent synchronization between devices A and B or between devices A and C (not shown in FIG. 4) will provide file S5_L3 to device A and update the inventory lists of the devices being synchronized.

In this way, device D has participated in a data transfer that has been used for a subsequent altruistic data caching, followed by cooperative updating within a Data Sharing Group. This shows how the present invention can be implemented to complement conventional update mechanisms and conventional devices.

### Additional Embodiments and Extensions

The embodiments described in detail above include transmitting representations of installed programs and their code levels between devices, as a way of notifying communication-partner devices of the update requirements of the other partners. These example implementations of the invention involve synchronization managers of communication partner devices requesting any available updates to a set of installed programs. Other embodiments of the invention may exchange update requirements in different ways—for example transmitting more complex definitions of the types of files required. The transmitted update requirements may be associated with license terms for the programs if a device is sold with a license to obtain software patches for installed programs and to obtain upgrades up to a specified program release number. If updates are identified at a communication partner that the current device is not authorized to obtain, the device user can be sent a notification of this event so that they can make a judgement regarding whether to pay an additional license fee or to disregard the available update.

The updating of communication partner devices may not be limited to updated versions of existing program and data files, and may include update requirements that specify topic names for data files of interest or file type identifiers that extend beyond the currently installed set of files. Documents, news items, share prices, device drivers and versioned application programs are all examples of items that may be updated in a cooperative manner according to the present invention.

The exemplary embodiments described above with reference to FIGS. 3 and 4 included caching available updates when any device in a Data Sharing Group has a requirement for the update (for example, each device that holds a lower code level of a program file for which a higher code level is available). The embodiments included saving and retaining update files until it is confirmed that all of the devices that require an update have received the update. Other embodiments of the invention seek to strike a balance between the processing costs and the advantages of cooperative and altruistic updating. Examples of such optimised solutions are described below. The processing ‘costs’ can include impacts on data processing performance and reductions in the amount of storage space available for other tasks.

A first example solution retains update files in cache storage for a limited period of time. That is, a synchronization manager at a first device is willing to altruistically cache files on behalf of other devices for a defined period of time, but deletes unused files after the time period has expired or compresses the unused files and saves them to a different storage area.

A second example solution provides a configuration setting for the synchronization manager such that update files can be deleted from cache storage of a first device, after a timer expiry, as long as at least one other device in the Data Sharing Group has received the update from the first device. Similarly, the synchronization manager could be configured to not receive an update if it is aware that at least one other device in the Data Sharing Group already has that update.

A third example solution assesses the constraints and costs associated with transmitting an item between two devices, to determine whether an update transmission should take place at a particular time. The item may be software, firmware, or any other files, documents or data. The constraints and costs that are considered are selected from a set of criteria including: the size of the file to be transferred, the amount of memory space available, the amount of battery power available to a device that is not currently connected to an external electricity supply, and characteristics of the available connection including bandwidth, signal quality and security. In one embodiment, the constraints and costs are assessed together with perceived benefits of updating. The criteria used in the assessment of perceived benefits are selected from a set of criteria including: the previous success rate for updates between relevant devices, how dependent a device is on updates from the other device (for example, is this effectively the only source of updates), how critical the update is and how out-of-date a current software version is.

This third example solution can be implemented as follows. A matrix is maintained at each device including both the data sharing policies (such as whether A can send to B, as described earlier) and a set of values representing a set of criteria that can influence whether a data transfer is likely to succeed or fail. That is, a matrix at device A will include one or more values representing a likelihood that a data update cached at device A for device B would be transferred successfully to B. This value representing a likelihood of success can be used to influence a decision regarding whether a particular data transfer should proceed at a particular point in time. In particular, the one or more values may be applied as weightings that have the potential to modify bit values (such as shown in Table 3). If the result of applying the weighting to a positive bit value in the table is a new value that is less than a threshold value, this new value indicates that a data transfer should not occur at the present time.

One of the factors that determines the weightings is the success and failure history for recent transfers of data items from A to B, but weightings can also be influenced by policy considerations such as whether B is entirely reliant on A for updates or could equally well obtain updates from other devices. Weightings can be adjusted in response to an identification of the available connection bandwidth. In particular, a decision is made to proceed with a data transfer when the data transfer is consistent with the data sharing policies and the relevant weighting is higher than a threshold.

The weighting value for transfers from A to B may differ from the weighting value from B to A, for example because of differences between the history of success and failure for different directions of data transfer, or because the communication link is an asymmetric link that favours transmission in one direction.

As noted above, a successful transfer of a cached data item from A to B will cause an update to the weighting value held by device A in respect of transfers to device B. A failure to transfer the cached data item successfully (for example, because of loss of data due to a poor quality connection, or because another device succeeded in updating device B before this was achieved by device A) will lead to a reduction of the respective weighting value.

In this way, an adaptive assessment of the likelihood of a data transfer succeeding is combined with defined data sharing policies for a set of devices within a Data Sharing Group, and this is used to control cooperative sharing of data items between devices.

The example embodiments described above include a user-determination of whether to establish a data sharing group as well as a user-determination of the data sharing policies (as shown in FIG. 2A). In another embodiment, the establishment of a data sharing group is fully automated by respective synchronization managers when an available connection is discovered between devices. Identification of a new Bluetooth connection may be a trigger event that can invoke the synchronization manager 140 to initiate communications with the synchronization manager of the connected device. If two devices are within each other's transmission range or are otherwise connectable, the period of time that has elapsed since a last synchronization may be a factor determining whether to resynchronize. The synchronization managers can then check whether the connected devices are registered communication partners, and whether they each hold any updated files that are of interest to the other devices.

1. A method for sharing data items between data processing devices, for data items such as computer program updates and data files, comprising the steps of:
maintaining, at a first device, a list of update requirements for at least a second device;
in response to identification of a data item that is available for download from a data source, comparing the available data item with the list of update requirements for the second device;
in response to determining a match between the available data item and the list of update requirements, the first device obtaining the data item from the data source for subsequent transfer to the second device.

2. The method of claim 1, further comprising the steps of:
establishing a connection between the first device and the second device; and
comparing data items saved at the first device with the update requirements of the second device; and
in response to said comparing identifying a match between a data item saved at the first device and an update requirement of the second device, transmitting the saved data item to the second device.

3. The method of claim 2, wherein at least the first device and the second device are members of a Data Sharing Group, the Data Sharing Group comprising a set of data processing devices that each maintain a list of update requirements for other members of the Data Sharing Group.

4. The method of claim 2, wherein at least the first device and the second device are members of a Data Sharing Group, the Data Sharing Group comprising a set of data processing devices and at least one data processing device within the set maintaining a list of update requirements for other members of the Data Sharing Group.

5. The method of claim 4, wherein the data source is also a member of the Data Sharing Group.

6. The method of claim 5, wherein the Data Sharing Group is established in response to user selection of a set of communication-partner devices.

7. The method of claim 5, wherein the Data Sharing Group is established in response to identification of a connection between two data processing devices.

8. The method of claim 7, wherein the first device, the second device and the data source are wireless-communication devices.

9. The method of claim 8, wherein the method further comprises, subsequent to determining a match between the available data item and the list of update requirements and before obtaining the data item from the data source, the step of:
checking whether a value representing a likelihood of successful transfer of the data item from the first device to the second device is above a threshold value, and determining that the obtaining step should not proceed if the likelihood value is below the threshold value.

10. A data processing apparatus comprising:
data storage means; and
synchronization manager means for controlling the data processing apparatus comprising:
means for maintaining a list of update requirements for at least a second data processing apparatus;
in response to obtaining a data item, means for comparing the obtained data item with the list of update requirements for the second data processing apparatus; and
in response to determining a match between the obtained data item and the list of update requirements for the second data processing apparatus, means for caching the obtained data item for subsequent transfer to the second data processing apparatus.

11. The apparatus of claim 10, further comprising:
means for establishing a connection between the first device and the second device; and
means for comparing data items saved at the first device with the update requirements of the second device; and
in response to said means for comparing identifying a match between a data item saved at the first device and an update requirement of the second device, means for transmitting the saved data item to the second device.

12. The apparatus of claim 11, wherein at least the first device and the second device are members of a Data Sharing Group, the Data Sharing Group comprising a set of data processing devices that each maintain a list of update requirements for other members of the Data Sharing Group.

13. The apparatus of claim 11, wherein at least the first device and the second device are members of a Data Sharing Group, the Data Sharing Group comprising a set of data processing devices and at least one data processing device within the set maintaining a list of update requirements for other members of the Data Sharing Group.

14. The apparatus of claim 13, wherein the data source is also a member of the Data Sharing Group.

15. The apparatus of claim 14, wherein the Data Sharing Group is established in response to user selection of a set of communication-partner devices.

16. The apparatus of claim 14, wherein the Data Sharing Group is established in response to identification of a connection between two data processing devices.

17. The apparatus of claim 16, wherein the first device, the second device and the data source are wireless-communication devices.

18. The apparatus of claim 17, further comprising, subsequent to determining a match between the available data item and the list of update requirements and before obtaining the data item from the data source,
means for checking whether a value representing a likelihood of successful transfer of the data item from the first device to the second device is above a threshold value, and means for determining that the data item obtained should not proceed if the likelihood value is below the threshold value.

19. A computer program comprising a data set of program code instructions for controlling a data processing device, comprising:
a data storage means, and a synchronization manager for controlling the data processing apparatus to perform the method steps of:
program code instruction means for maintaining a list of update requirements for at least a second data processing apparatus;
in response to obtaining a data item, program code instruction means for comparing the obtained data item with the list of update requirements for the second data processing apparatus; and
in response to determining a match between the obtained data item and the list of update requirements for the second data processing apparatus, program code instruction means for caching the obtained data item for subsequent transfer to the second data processing apparatus
